(19) United States
(12) Patent Application Publication
(10) Pub. No.: US 2024/0053276 A1
(43) Pub. Date: Feb. 15, 2024

(54) SIX-SIDED INSPECTION MECHANISM FOR PART AND PART APPEARANCE PACKAGING INSPECTION DEVICE

(71) Applicant: Dongguan Jiezhan Precision Equipment Co., Ltd, Dongguan (CN)

(72) Inventor: Xingke Wang, Dongguan (CN)

(21) Appl. No.: 18/219,119

(22) Filed: Jul. 7, 2023

(30) Foreign Application Priority Data
Aug. 12, 2022 (CN) 202222131575.X

(51) Int. Cl. G01N 21/88

(52) U.S. Cl. CPC G01N 21/8803

(57) ABSTRACT

Disclosed are a six-sided inspection mechanism for a part and a part appearance packaging inspection device. The six-sided inspection mechanism for a part includes a feeding platform configured to convey a part to an inspection station for inspection; a charge-coupled device (CCD) five-sided inspection assembly, where the feeding platform drives the part to enter the CCD five-sided inspection assembly for inspection; and a CCD top inspection assembly arranged on the inspection platform, located on a side of the CCD five-sided inspection assembly, and configured to inspect a top end face of the part. In the six-sided inspection mechanism for a part and the part appearance packaging inspection device, the mechanism can complete appearance inspection of six sides of the part by means of the CCD five-sided inspection assembly and the CCD top inspection assembly, shorten an inspection time, and improve inspection efficiency.

### TECHNICAL FIELD

The present disclosure relates to the technical field of part appearance inspection devices, and in particular, to a six-sided inspection mechanism for a part and a part appearance packaging inspection device.

### BACKGROUND

Currently, with the continuous development of industrial technology, more and more micro parts and small hardware parts are produced and machined. Micro parts and small hardware parts need to undergo appearance inspection after production and before leaving factory, so as to ensure the quality of parts. The parts include, but are not limited to, resistance elements, patch elements, chip elements, and micro-hardware products.

Conventional part appearance inspection is generally completed by a hand-held inspection probe. This inspection method is inefficient. In addition, it is difficult to effectively inspect surface quality and sizes of parts.

With the development of science and technology, an existing inspection device can inspect different end faces of parts by charge-coupled device (CCD) inspection devices when the parts sequentially pass through an inspection station. This improves inspection efficiency. However, because each part has a plurality of end faces, the part needs to be transferred in different devices when different end faces are inspected, and six sides of the part are inspected by six CCD inspection devices. The existing inspection device has long inspection time and low inspection efficiency, and an inspection instrument has a high manufacturing cost and is difficult to maintain, which makes it more difficult for staff to prepare subsequently.

### SUMMARY

The present disclosure aims to solve at least the technical problem existing in the prior art that an existing inspection device has long inspection time and low inspection efficiency, and an inspection instrument has a high manufacturing cost and is difficult to maintain, which makes it more difficult for staff to prepare subsequently. Therefore, the present disclosure provides a six-sided inspection mechanism for a part and a part appearance packaging inspection device, which can synchronously inspect a plurality of surfaces of a part, shorten an inspection time, and improve inspection efficiency. Moreover, there are a small number of CCD inspection groups used in the mechanism, which effectively reduces manufacturing costs and reduces maintenance difficulty while ensuring inspection quality, thereby facilitating subsequent preparation.

A six-sided inspection mechanism for a part according to some embodiments of the present disclosure includes an inspection platform, and includes:
a feeding platform rotatably connected to the inspection platform, and configured to convey a part to an inspection station for inspection;
a CCD five-sided inspection assembly arranged on the inspection platform, where the feeding platform drives the part to enter the CCD five-sided inspection assembly for inspection; and
a CCD top inspection assembly arranged on the inspection platform, located on a side of the CCD five-sided inspection assembly, and configured to inspect a top end face of the part, where
the CCD five-sided inspection assembly includes a prism assembly and a first inspection lens, and the prism assembly is configured to enable the first inspection lens to acquire image information of five end faces of the part.

According to some embodiments of the present disclosure, workpiece loading positions are evenly distributed on a periphery of the feeding platform, and the workpiece loading positions are configured to bear the part; and the six-sided inspection mechanism for a part includes a platform driving mechanism, where the platform driving mechanism is in transmission connection with the feeding platform, and the platform driving mechanism is configured to drive the part on the feeding platform to sequentially pass through the CCD five-sided inspection assembly and the CCD top inspection assembly.

According to some embodiments of the present disclosure, the prism assembly includes a total reflection mirror, the first inspection lens is transversely arranged below the inspection platform, the total reflection mirror is located on a side of the first inspection lens, and the total reflection mirror is configured to enable the first inspection lens to acquire bottom image information of the part.

According to some embodiments of the present disclosure, the prism assembly includes a mirror seat and four side-face reflection mirrors, where the mirror seat is arranged on the inspection platform, a surface of the mirror seat is provided with an inspection hole position, and the side-face reflection mirrors are arranged around a periphery of the inspection hole position; and when the part moves to the inspection hole position, the first inspection lens obtains side-face image information of the part by means of reflection paths of the total reflection mirror and the side-face reflection mirrors.

According to some embodiments of the present disclosure, the total reflection mirror has a reflection range not less than a diameter surrounded by the side-face reflection mirrors, to enable an imaging area of the first inspection lens to cover the side-face reflection mirrors and ensure that the first inspection lens can acquire the side-face image information of the part by means of the side-face reflection mirrors.

According to some embodiments of the present disclosure, the six-sided inspection mechanism for a part includes an electromagnetic transfer assembly arranged on a surface of the inspection platform and located on a side of the mirror seat, where the electromagnetic transfer assembly is configured to transfer the part from the feeding platform to the inspection hole position for five-sided inspection.

According to some embodiments of the present disclosure, the electromagnetic transfer assembly includes an electromagnetic suction head, a translation driving assembly, and a lifting driving assembly, where the electromagnetic suction head is connected to the lifting driving assembly, and the lifting driving assembly is connected to the translation driving assembly; and the translation driving assembly is configured to drive the electromagnetic suction head to move between the feeding platform and the inspection hole position, and the lifting driving assembly is configured to drive the part at the electromagnetic suction head to enter or leave the inspection hole position; and the electromagnetic suction head is configured to suck the part.

According to some embodiments of the present disclosure, the total reflection mirror and the side-face reflection mirrors each have a right-angled prism structure.

According to some embodiments of the present disclosure, the CCD top inspection assembly includes a second inspection lens, and the second inspection lens is configured to acquire top image data of the part at the feeding platform.

A part appearance packaging inspection device according to some embodiments of the present disclosure includes the above six-sided inspection mechanism for a part.

The six-sided inspection mechanism for a part and the part appearance packaging inspection device according to some embodiments of the present disclosure have at least the following beneficial effects: The mechanism can complete appearance inspection of six sides of the part by means of the CCD five-sided inspection assembly and the CCD top inspection assembly, shorten an inspection time, and improve inspection efficiency. Moreover, there are a small number of CCD assemblies used, which effectively reduces manufacturing costs and reduces subsequent preparation and maintenance difficulty while maintaining original inspection performance of the device.

Additional aspects and advantages of the present disclosure are to be partially provided in the following description, and partially become evident in the following description, or understood through the practice of the present disclosure.

### BRIEF DESCRIPTION OF THE DRAWINGS

The above and/or additional aspects and advantages of the present disclosure will become apparent and readily comprehensible from the description of embodiments in conjunction with the following accompanying drawings.

FIG. 1 is a schematic perspective view of a six-sided inspection mechanism for a part according to an embodiment of the present disclosure;

FIG. 2 is a schematic enlarged view of a part A of FIG. 1;

FIG. 3 is a partial sectional view of a six-sided inspection mechanism for a part according to an embodiment of the present disclosure;

FIG. 4 is a schematic diagram of a side-face reflection mirror of a six-sided inspection mechanism for a part according to an embodiment of the present disclosure; and

FIG. 5 is a schematic view of an electromagnetic transfer assembly of a six-sided inspection mechanism for a part according to an embodiment of the present disclosure.

### REFERENCE NUMERALS

Inspection platform 100, feeding platform 210, workpiece loading position 211, platform driving mechanism 220,

CCD five-sided inspection assembly 300, total reflection mirror 311, side-face reflection mirror 312, mirror seat 313, inspection hole position 313-1, first inspection lens 320, electromagnetic transfer assembly 330, electromagnetic suction head 331, translation driving assembly 332, lifting driving assembly 333, CCD top inspection assembly 400, second inspection lens 410.

### DETAILED DESCRIPTION OF THE EMBODIMENTS

The embodiments of the present disclosure are described below in detail. Examples of the embodiments are shown in the accompanying drawings. The same or similar numerals represent the same or similar elements or elements having the same or similar functions throughout the description. The embodiments described below with reference to the accompanying drawings are exemplary, are used only for explaining the present disclosure, and should not be construed as a limitation to the present disclosure.

In the description of the present disclosure, it should be understood that orientation or position relationships indicated by terms “upper”, “lower”, “front”, “rear”, “left”, “right”, “top”, “bottom”, etc. are orientation or position relationships as shown in the accompanying drawings, and these terms are just used to facilitate description of the present disclosure and simplify the description, but not to indicate or imply that the mentioned apparatus or element must have a specific orientation and must be constructed and operated in a specific orientation, and thus cannot be construed as a limitation to the present disclosure.

In the description of the present disclosure, “several” means one or more, “a plurality of” means two or more, “greater than”, “less than”, “over” and the like are construed as excluding the number, and “above”, “below”, “within” and the like are construed as including the number. The “first” and “second” in the description are merely intended to distinguish technical features, rather than to indicate or imply relative importance or implicitly indicate a number of the indicated technical features or implicitly indicate a sequence relationship of the indicated technical features.

In the description of the present disclosure, unless otherwise explicitly defined, the words such as “arrange”, “mount” and “connect” should be understood in a broad sense, and those skilled in the art can reasonably determine the specific meanings of the above words in the present disclosure with reference to specific contents of the technical solutions.

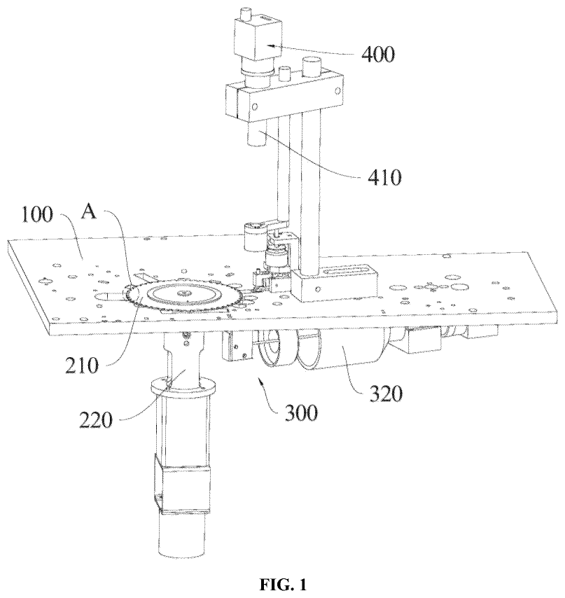

A six-sided inspection mechanism for a part according to an embodiment of the present disclosure is described below with reference to FIGS. 1 to 5.

As shown in FIGS. 1 to 5, the six-sided inspection mechanism for a part includes an inspection platform 100, a feeding platform 210, a CCD five-sided inspection assembly 300, and a CCD top inspection assembly 400. Specifically, the inspection platform 100 bears the above components, and the feeding platform 210 is rotatably connected to the inspection platform 100, and can continuously convey parts to an inspection station for appearance inspection. The inspection station refers to working areas of the CCD five-sided inspection assembly 300 and the CCD top inspection assembly 400. An element feeding station is provided on a side of the feeding platform 210. Parts at the element feeding station are continuously loaded into the feeding platform 210, the feeding platform 210 completes appearance inspection of the parts by means of the two CCD assemblies, and finally the parts are transferred to a packaging station by a manipulator or another auxiliary device for packaging.

The CCD five-sided inspection assembly 300 is arranged on the inspection platform 100, and the feeding platform 210 drives each part to enter the CCD five-sided inspection assembly 300 for appearance inspection. The CCD top inspection assembly 400 is arranged on the inspection platform 100, located on a side of the CCD five-sided inspection assembly 300, and configured to inspect a top end face of the part. The CCD five-sided inspection assembly 300 and the CCD top inspection assembly 400 can be exchanged with each other in inspection sequence. In this embodiment, the feeding platform 210 drives the part to first pass through the CCD five-sided inspection assembly 300 for appearance inspection, and then pass through the CCD top inspection assembly 400 for appearance inspection, thus completing six-sided appearance inspection. In some other embodiments, the feeding platform 210 may drive the part to first pass through the CCD top inspection assembly 400 and then pass through the CCD five-sided inspection assembly 300, thus completing six-sided appearance inspection of the part. In the present disclosure, sequence combinations of CCD assemblies are not described one by one. It should be understood that the flexible transformation of the sequence combination of CCD assemblies without departing from the basic concept of the present disclosure should be regarded as falling within the protection scope defined by the present disclosure.

The CCD five-sided inspection assembly 300 includes a prism assembly and a first inspection lens 320, and the prism assembly is configured to enable the first inspection lens 320 to acquire image information of five end faces of the part. After being reflected by the prism assembly, light enters the first inspection lens 320 for imaging, enabling the first inspection lens 320 to obtain five-sided image information of the part except a top image.

An existing part appearance inspection device usually has a plurality of CCD assemblies, each of which corresponds to one end face of the part for inspection. The CCD assemblies are sequentially executed, and sequentially complete inspection of six sides, with a long inspection time. Due to a large number of CCD assemblies, the manufacturing cost of the inspection device is as high as RMB hundreds of thousands yuan, and tight mounting between the CCD assemblies does not facilitate subsequent maintenance and overhaul by staff, making maintenance difficult.

However, the six-sided inspection mechanism according to the present disclosure can complete six-sided inspection of the part by using only two CCD assemblies, thereby greatly reducing the manufacturing cost of the inspection device. An arrangement gap between the two CCD assemblies is large, and there is low difficulty in subsequent maintenance, which facilitates daily maintenance by staff and makes the maintenance cost low. Moreover, the CCD five-sided inspection assembly 300 can inspect five sides of the part, thereby greatly shortening the inspection time, improving inspection efficiency, shortening the length of the inspection station, enabling the part to be inspected and enter the packaging station more quickly, and improving part packaging efficiency.

The six-sided inspection mechanism according to the present disclosure can not only inspect appearances of electronic elements such as a resistance element, a patch element, and a chip element, but also inspect appearances of miniature hardware, small stamping hardware, etc.

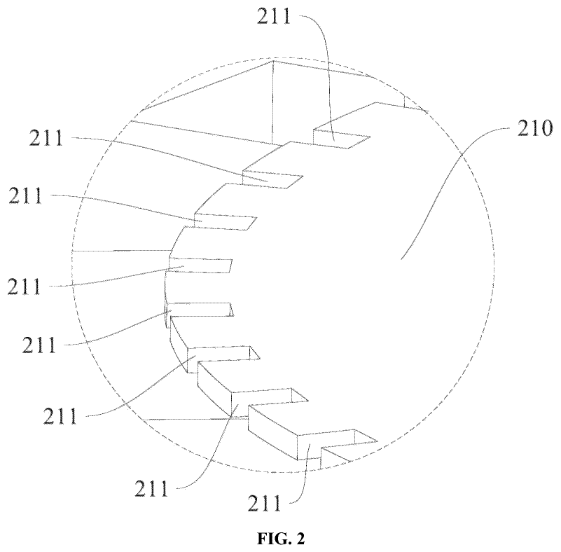

In some embodiments of the present disclosure, as shown in FIGS. 1 and 2, workpiece loading positions 211 are evenly distributed on a periphery of the feeding platform 210, and the workpiece loading positions 211 are configured to bear the part. The six-sided inspection mechanism for a part further includes a platform driving mechanism 220 for driving the feeding platform 210 to rotate, where the platform driving mechanism 220 is in transmission connection with the feeding platform 210, and the platform driving mechanism 220 is configured to drive the part on the feeding platform 210 to sequentially pass through the CCD five-sided inspection assembly 300 and the CCD top inspection assembly 400.

Specifically, in this embodiment, the feeding platform 210 is in a disc shape, and the workpiece loading positions 211 are arranged around the periphery of the feeding platform 210. Distances between the workpiece loading positions 211 are equal. The platform driving mechanism 220 is arranged below the inspection platform 100, and an output shaft of the platform driving mechanism 220 is connected to the feeding platform 210 above the inspection platform 100, thereby driving the feeding platform 210 to rotate, so that the part at the workpiece loading position 211 sequentially passes through the CCD five-sided inspection assembly 300 and the CCD top inspection assembly 400 for appearance inspection. The workpiece loading position 211 has a size equal to that of the part, so that the workpiece loading position can clamp the part and drive the part to move.

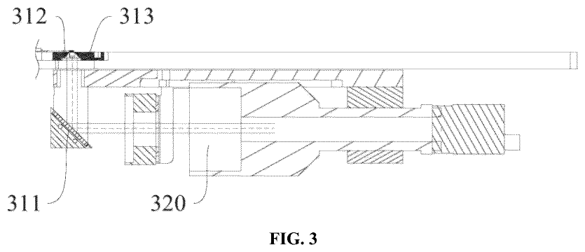

In some embodiments of the present disclosure, as shown in FIGS. 1 and 3, the prism assembly includes a total reflection mirror 311, the first inspection lens 320 is transversely arranged below the inspection platform 100, the total reflection mirror 311 is located on a side of the first inspection lens 320, and the total reflection mirror 311 is configured to enable the first inspection lens 320 to acquire bottom image information of the part.

Specifically, the first inspection lens 320 is transversely arranged below the inspection platform 100, so that the first inspection lens 320 can be biased. The first inspection lens 320 is prevented from approaching the platform driving mechanism 220, which reduces the distribution density of components in the device and facilitates subsequent maintenance and overhaul of the inspection device. The total reflection mirror 311 is arranged below the inspection platform 100, which can change a path of light, and the light path at the part enters the first inspection lens 320 under a reflection action of the total reflection mirror 311, so that the transverse first inspection lens 320 can acquire image information of a lower portion of the part. The first inspection lens 320 can acquire bottom image information of the part by means of the total reflection mirror 311.

It should be understood that it is not the only implementation to use the total reflection mirror 311 to reflect the light into the first inspection lens 320 for imaging. In some other embodiments, the first inspection lens 320 may also be vertically placed to be aligned with the lower portion of the part, so that the light at the part propagates into the first inspection lens 320 in a straight line, and the light propagation path is more direct, thereby improving the imaging quality. Specifically, the first inspection lens 320 is placed transversely or vertically, which is selected according to the size of an actual bottom space of the device. It should be understood that the manner of placing the first inspection lens 320 and use of the total reflection mirror 311 are flexibly transformed without departing from the basic concept of the present disclosure, which should be regarded as falling within the protection scope defined by the present disclosure.

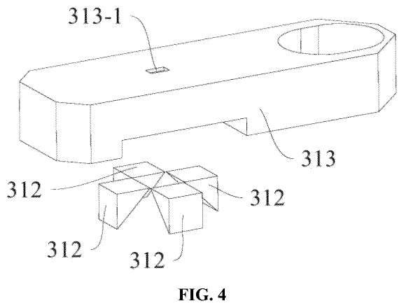

In a further embodiment, as shown in FIGS. 3 and 4, the prism assembly includes a mirror seat 313 and four side-face reflection mirrors 312, where the mirror seat 313 is arranged on the inspection platform 100, a surface of the mirror seat 313 is provided with an inspection hole position 313-1, and the side-face reflection mirrors 312 are arranged around a periphery of the inspection hole position 313-1. The feeding platform 210 drives the part to the position of the mirror seat 313, and the part moves into the inspection hole position 313-1. When the part is located in the inspection hole position 313-1, four groups of side-face reflection mirrors 312 are correspondingly arranged around the part, and each side-face reflection mirror 312 corresponds to one side face of the part.

Specifically, when the part moves to the inspection hole position 313-1, the first inspection lens 320 obtains side-face image information of the part by means of reflection paths of the total reflection mirror 311 and the side-face reflection mirrors 312. That is, the first inspection lens 320 can directly acquire bottom image information of the part under the reflection action of the total reflection mirror 311. Image information of four side faces of the part can be obtained by means of the light path at the bottom periphery through the action of the four side-face reflection mirrors 312. The first inspection lens 320 can acquire five-sided product images every time it photographs an image. The inspection device compares the product images obtained by the first inspection lens 320 with a standard product image in a system, so as to determine whether the five-sided product images meet the standards. When any one of the five-sided product images does not match the standard product image, the part inspected in this round fails.

In a further embodiment, as shown in FIGS. 3 and 4, in order to ensure that light from the side-face reflection mirror 312 can be reflected into the first inspection lens 320 through the total reflection mirror 311. The total reflection mirror 311 has a reflection range not less than a diameter surrounded by the side-face reflection mirrors 312, to enable an imaging area of the first inspection lens 320 to cover the side-face reflection mirrors 312 and ensure that the first inspection lens 320 can acquire the side-face image information of the part by means of the side-face reflection mirrors 312. That is, a light path reflection area of the total reflection mirror 311 can cover an area surrounded by the four side-face reflection mirrors 312, so that it is ensured that the light from the side-face reflection mirror 312 can be reflected into the first inspection lens 320 by the total reflection mirror 311.

In a further embodiment, the total reflection mirror 311 and the side-face reflection mirrors 312 each have a right-angled prism structure, and a reflection angle of the right-angled prism is a right angle that is 90°, which can make the light path bend by 90°. The light path from the side-face reflection mirror 312 enters the first inspection lens 320 after two reflections. The light path from the bottom of the part enters the first inspection lens 320 after one reflection by the total reflection mirror 311.

It should be understood that a specific reflection path of the prism assembly and the structure of each reflection mirror are not the only implementation. In the present disclosure, a specific reflection path of the prism assembly and the structure of each reflection mirror are not described one by one. It should be understood that the flexible transformation of the specific reflection path of the prism assembly and the structure of each reflection mirror without departing from the basic concept of the present disclosure should be regarded as falling within the protection scope defined by the present disclosure.

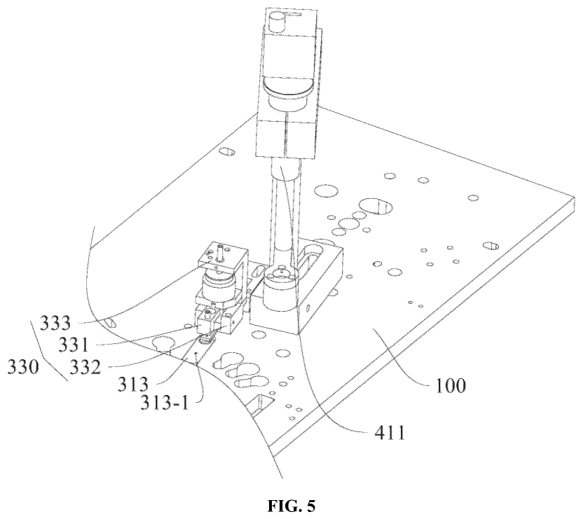

In some embodiments of the present disclosure, as shown in FIGS. 4 and 5, the six-sided inspection mechanism for a part includes an electromagnetic transfer assembly 330 arranged on a surface of the inspection platform 100 and located on a side of the mirror seat 313, where the electromagnetic transfer assembly 330 is configured to transfer the part from the feeding platform 210 to the inspection hole position 313-1 for five-sided inspection. Specifically, the electromagnetic transfer assembly 330 can suck the part on the feeding platform 210 into the inspection hole position 313-1.

In a further embodiment, as shown in FIG. 5, the electromagnetic transfer assembly 330 includes an electromagnetic suction head 331, a translation driving assembly 332, and a lifting driving assembly 333, where the electromagnetic suction head 331 is connected to the lifting driving assembly 333, and the lifting driving assembly 333 is connected to the translation driving assembly 332. The lifting driving assembly 333 and the translation driving assembly 332 each may have a linear guide rail conveying structure or a stepping motor transmission structure. The structures of the lifting driving assembly 333 and the translation driving assembly 332 pertain to technical solutions well known to those skilled in the art, and will not be described again in detail in this embodiment. An end face of the electromagnetic suction head 331 in contact with the part is magnetized after being electrified, and can magnetically suck a top of the part, thereby driving the part into the inspection hole position 313-1. When the CCD five-sided inspection assembly 300 completes the inspection, the electromagnetic suction head 331 drives the part back to the original workpiece loading position 211, and the feeding platform 210 drives the part to a next station.

The translation driving assembly 332 is configured to drive the electromagnetic suction head 331 to move between the feeding platform 210 and the inspection hole position 313-1, and the lifting driving assembly 333 is configured to drive the part at the electromagnetic suction head 331 to enter or leave the inspection hole position 313-1. The electromagnetic suction head 331 is configured to suck the part.

It should be understood that the use of the suction structure of the electromagnetic suction head 331 for the electromagnetic transfer assembly 330 is not the only implementation. In some other embodiments, a micro pneumatic suction head structure may also be used to suck the part. The suction structure and manner for the part according to the present disclosure are not described one by one. It should be understood that the flexible transformation of the suction structure and manner for the part without departing from the basic concept of the present disclosure should be regarded as falling within the protection scope defined by the present disclosure. In some embodiments of the present disclosure, as shown in FIGS. 1 and 5, the CCD top inspection assembly 400 includes a second inspection lens 410, and the second inspection lens 410 is configured to acquire top image data of the part at the feeding platform 210. Specifically, a detailed structure of the CCD top inspection assembly 400 pertains to technical solutions well known to those skilled in the art, and will not be described again in detail in this embodiment.

In some embodiments of the present disclosure, the CCD five-sided inspection assembly 300 and the electromagnetic transfer assembly 330 may be arranged opposite to the arrangement positions specified in the present disclosure. That is, the CCD five-sided inspection assembly 300 is arranged above the inspection platform 100, and the prism assembly is correspondingly arranged above the inspection platform 100. The electromagnetic transfer assembly 330 is arranged below the inspection platform 100, and the part is transferred from the workpiece loading position 211 to the inspection hole position 313-1 by the electromagnetic transfer assembly 330, and the top and side walls of the part are subjected to five-sided inspection by the CCD five-sided inspection assembly 300. The CCD top inspection assembly 400 is arranged below the inspection platform 100 to inspect a bottom of the part.

The same inspection effect can be achieved by mainly arranging the CCD five-sided inspection assembly 300, the CCD top inspection assembly 400 and the electromagnetic transfer assembly 330 in mirror layout with the inspection platform 100 as a symmetrical plane. In this case, the CCD five-sided inspection assembly 300 can still inspect five end faces of the part, while the CCD top inspection assembly 400 is responsible for inspecting the bottom of the part.

The part appearance packaging inspection device according to the present disclosure includes the six-sided inspection mechanism for a part, where five-sided synchronous appearance inspection of the part is realized by the CCD five-sided inspection mechanism, thereby effectively shortening the inspection time and the inspection travel. Moreover, a number of CCD assemblies used is reduced, which can further reduce the manufacturing cost of the device, greatly reduce the production cost, and enhance the market competitiveness of the device.

In the description of this specification, the description with reference to the terms “an embodiment”, “some embodiments”, “an illustrative embodiment”, “an example”, “a specific example”, or “some examples” means that specific features, structures, materials or characteristics described with reference to the embodiment or example are included in at least one embodiment or example of the present disclosure. In this specification, the schematic representations of the above terms do not necessarily refer to the same embodiment or example. Moreover, the specific features, structures, materials or characteristics described may be combined in any suitable manner in any one or more embodiments or examples.

Although the embodiments of the present disclosure have been illustrated and described, those of ordinary skill in the art can understand that various changes, modifications, replacements, and alterations may be made to these embodiments without departing from the principle and tenet of the present disclosure, and the scope of the present disclosure is defined by the claims and equivalents thereof.

What is claimed is:

1. A six-sided inspection mechanism for a part, comprising an inspection platform (100), wherein the mechanism comprises:
a feeding platform (210) rotatably connected to the inspection platform (100), and configured to convey a part to an inspection station for inspection;
a charge-coupled device (CCD) five-sided inspection assembly (300) arranged on the inspection platform (100), wherein the feeding platform (210) drives the part to enter the CCD five-sided inspection assembly (300) for inspection; and
a CCD top inspection assembly (400) arranged on the inspection platform (100), located on a side of the CCD five-sided inspection assembly (300), and configured to inspect a top end face of the part, wherein
the CCD five-sided inspection assembly (300) comprises a prism assembly and a first inspection lens (320), and the prism assembly is configured to enable the first inspection lens (320) to acquire image information of five end faces of the part.

2. The six-sided inspection mechanism for a part according to claim 1, wherein workpiece loading positions (211) are evenly distributed on a periphery of the feeding platform (210), and the workpiece loading positions (211) are configured to bear the part; and
the six-sided inspection mechanism comprises a platform driving mechanism (220), wherein the platform driving mechanism (220) is in transmission connection with the feeding platform (210), and the platform driving mechanism (220) is configured to drive the part on the feeding platform (210) to sequentially pass through the CCD five-sided inspection assembly (300) and the CCD top inspection assembly (400).

3. The six-sided inspection mechanism for a part according to claim 1, wherein the prism assembly comprises a total reflection mirror (311), the first inspection lens (320) is transversely arranged below the inspection platform (100), the total reflection mirror (311) is located on a side of the first inspection lens (320), and the total reflection mirror (311) is configured to enable the first inspection lens (320) to acquire bottom image information of the part.

4. The six-sided inspection mechanism for a part according to claim 3, wherein the prism assembly comprises a mirror seat (313) and four side-face reflection mirrors (312), wherein the mirror seat (313) is arranged on the inspection platform (100), a surface of the mirror seat (313) is provided with an inspection hole position (313-1), and the side-face reflection mirrors (312) are arranged around a periphery of the inspection hole position (313-1); and
when the part moves to the inspection hole position (313-1), the first inspection lens (320) obtains side-face image information of the part by means of reflection paths of the total reflection mirror (311) and the side-face reflection mirrors (312).

5. The six-sided inspection mechanism for a part according to claim 4, wherein the total reflection mirror (311) has a reflection range not less than a diameter surrounded by the side-face reflection mirrors (312), to enable an imaging area of the first inspection lens (320) to cover the side-face reflection mirrors (312) and ensure that the first inspection lens (320) acquires the side-face image information of the part by means of the side-face reflection mirrors (312).

6. The six-sided inspection mechanism for a part according to claim 4, comprising an electromagnetic transfer assembly (330) arranged on a surface of the inspection platform (100) and located on a side of the mirror seat (313), wherein the electromagnetic transfer assembly (330) is configured to transfer the part from the feeding platform (210) to the inspection hole position (313-1) for five-sided inspection, wherein the electromagnetic transfer assembly (330) comprises an electromagnetic suction head (331), a translation driving assembly (332), and a lifting driving assembly (333), wherein the electromagnetic suction head (331) is connected to the lifting driving assembly (333), and the lifting driving assembly (333) is connected to the translation driving assembly (332); and
the translation driving assembly (332) is configured to drive the electromagnetic suction head (331) to move between the feeding platform (210) and the inspection hole position (313-1), and the lifting driving assembly (333) is configured to drive the part at the electromagnetic suction head (331) to enter or leave the inspection hole position (313-1); and the electromagnetic suction head (331) is configured to suck the part.

7. The six-sided inspection mechanism for a part according to claim 4, wherein the total reflection mirror (311) and the side-face reflection mirrors (312) each have a right-angled prism structure.

8. The six-sided inspection mechanism for a part according to claim 5, wherein the total reflection mirror (311) and the side-face reflection mirrors (312) each have a right-angled prism structure.

9. The six-sided inspection mechanism for a part according to claim 6, wherein the total reflection mirror (311) and the side-face reflection mirrors (312) each have a right-angled prism structure.

10. The six-sided inspection mechanism for a part according to claim 1, wherein the CCD top inspection assembly (400) comprises a second inspection lens (410), and the second inspection lens (410) is configured to acquire top image data of the part at the feeding platform (210).

11. A part appearance packaging inspection device, comprising the six-sided inspection mechanism for a part according to claim 1.

12. A part appearance packaging inspection device, comprising the six-sided inspection mechanism for a part according to claim 2.

13. A part appearance packaging inspection device, comprising the six-sided inspection mechanism for a part according to claim 3.

14. A part appearance packaging inspection device, comprising the six-sided inspection mechanism for a part according to claim 4.

15. A part appearance packaging inspection device, comprising the six-sided inspection mechanism for a part according to claim 5.

16. A part appearance packaging inspection device, comprising the six-sided inspection mechanism for a part according to claim 6.

17. A part appearance packaging inspection device, comprising the six-sided inspection mechanism for a part according to claim 7.

18. A part appearance packaging inspection device, comprising the six-sided inspection mechanism for a part according to claim 8.

19. A part appearance packaging inspection device, comprising the six-sided inspection mechanism for a part according to claim 9.

20. A part appearance packaging inspection device, comprising the six-sided inspection mechanism for a part according to claim 10.
